(19) United States
(12) Patent Application Publication
(10) Pub. No.: US 2018/0009583 A1
(43) Pub. Date: Jan. 11, 2018

(54) RUBBER STOPPER FOR MEDICINE CONTAINER AND MEDICINE-ACCOMMODATED MEDICINE CONTAINER USING THE SAME

(71) Applicant: Terumo Kabushiki Kaisha, Tokyo (JP)

(72) Inventors: Keiko FUKUSHI, Hadano-shi (JP); Yoshihiko ABE, Odawara-shi (JP)

(73) Assignee: Terumo Kabushiki Kaisha, Tokyo (JP)

(21) Appl. No.: 15/712,738

(22) Filed: Sep. 22, 2017

Related U.S. Application Data
(63) Continuation of application No. PCT/JP2016/050354, filed on Jan. 7, 2016.

(30) Foreign Application Priority Data
Mar. 25, 2015 (JP) 2015-062335

(51) Int. Cl. B65D 51/00; B65D 47/14; B29L 31/56; A61J 1/14; B01L 3/00

(52) U.S. Cl. CPC B65D 51/002; B65D 47/141; B01L 3/50825; A61J 1/1406; B29L 2031/565

(57) ABSTRACT

A rubber stopper for a medicine container has a rubber stopper body and a coating layer directly applied to a surface exposed in the medicine container. The coating layer is more flexible than a forming material of the rubber stopper body. The said coating layer comprises a composition containing a silicone-based resin which comprises a condensate of a reactive silicone having a terminal silanol group, and wherein the condensate contains a siloxane bond derived from the silanol group.

### TECHNICAL FIELD

The present invention relates to a rubber stopper for a medicine container and a medicine-accommodated medicine container using the rubber stopper.

### BACKGROUND ART

A large number of medical containers sealed with a rubber stopper and accommodating a medicine are provided. The influence of the rubber stopper for the medical container on the medicine accommodated inside the medical container has come to be investigated. The influence of the rubber stopper on the denaturation of the medicine, the influence thereof on a decrease in the content of the medicine, and the like are investigated. More specifically, the adsorption of the medicine to the surface of the rubber stopper, the sorption of the medicine to the rubber stopper caused by the sorption of the medicine into the rubber stopper, and the elution of components forming the rubber stopper from a material used to form the rubber stopper are investigated. As medicines which are liable to cause these problems, platinum-based anti-cancer agents, protein preparations such as insulin, nitroglycerin, isosorbide dinitrate, nicardipine hydrochloride, monoammonium glycyrrhizinate, and the like are known.

As disclosed in patent document 1 (JP2014-79373A), there is proposed a rubber stopper for a medicine container, a so-called vial container. In the disclosure made therein, the inert film is layered on the portion of the rubber stopper which contacts a medicine. In the patent document 1, as the inert film layered on the rubber stopper, the fluorine-based resin or the olefin-based resin are exemplified. In the disclosure made in the patent document 1, the upper surface of the flange or the surface of the inert film layered on the rubber stopper is coated with the non-reactive silicone or the reactive silicone.

The present applicant proposed the gasket for the syringe as disclosed in patent document 2 [U.S. Pat. No. 8,968,260 (WO/2009/084646) and U.S. Pat. No. 9,345,837]. The gasket for the syringe is so formed as to liquid-tightly and slidably contact the inner surface of the outer cylinder of the syringe. The gasket for the syringe has the gasket body made of the elastic body and the coating layer formed on the portion thereof which contacts at least the syringe. The coating layer is formed of the composition containing the silicone-based resin which consists of the condensate of the reactive silicone having the end silanol group and which has the siloxane bond derived from the silanol group.

### PRIOR ART DOCUMENTS

### Patent Documents

Patent document 1: JP2014-79373A

Patent document 2: U.S. Pat. No. 8,968,260 (WO/2009/084646) and U.S. Pat. No. 9,345,837

### SUMMARY OF THE INVENTION

### Problem to be Solved by the Invention

Although the rubber stopper of the patent document 1 is effective, the inert film is used for the rubber stopper. Thus, the rubber stopper may become hard. The rubber stopper is subjected to the piercing of a piercing member such as an injection needle at a plurality of times. Thus, there is a case in which the medicine leaks from pierced portions. In the gasket for the syringe of the patent document 2, only the specific coating layer formed on the gasket is disclosed. The rubber stopper for the medicine container is not disclosed. The use of the coating layer for the rubber stopper for the medicine container is not suggested either.

It is an object of the present invention to provide a rubber stopper for a medicine container which maintains a high degree of flexibility, does not adsorb a medicine, prevents components forming the rubber stopper from eluting from a material used to form the rubber stopper, and prevents the medicine from flowing out from pierced portions of the rubber stopper even though the rubber stopper is subjected to the piercing of an injection needle at a plurality of times and provide a medicine-accommodated medicine container using the rubber stopper.

### Means for Solving the Problems

The means for achieving the above-described object is as described below.

A rubber stopper for a medicine container comprises a rubber stopper body and a coating layer directly applied to a surface of said rubber stopper body exposed in said medicine container, wherein said coating layer is more flexible than a forming material of said rubber stopper body and said coating layer comprises a composition containing a silicone-based resin which comprises a condensate of a reactive silicone having a terminal silanol group, and wherein said condensate contains a siloxane bond derived from said silanol group.

The means for achieving the above-described object is as described below.

A medicine-accommodated medicine container comprises a medicine container body having an open part; the above rubber stopper for a medicine container, which is mounted on an open part of said medicine container body and seals said open part; and a medicine accommodated inside said medicine container body.

### BRIEF DESCRIPTION OF THE DRAWINGS

FIG. 1 is a front view showing a rubber stopper for a medicine container according to one embodiment of the present invention.

FIG. 2 is a plan view of the rubber stopper for the medicine container shown in FIG. 1.

FIG. 3 is a bottom view of the rubber stopper for the medicine container shown in FIG. 1.

FIG. 4 is a sectional view taken along a line A-A of FIG. 1.

FIG. 5 is a front view showing a medicine-accommodated medicine container according to one embodiment of the present invention.

FIG. 6 is a sectional view taken along a line B-B of FIG. 5.

### MODE FOR CARRYING OUT THE INVENTION

The rubber stopper of the present invention for a medicine container is described below by using embodiments shown in the drawings.

The rubber stopper 1 comprises a rubber stopper body 2 and a coating layer 5 directly applied to an exposed surface, of the rubber stopper body 2, which is disposed inside the medicine container. The coating layer 5 is more flexible than a forming material of the rubber stopper body 2. The coating layer 5 comprises a composition containing a silicone-based resin which comprises a condensate of a reactive silicone having a terminal silanol group, and wherein the condensate contains a siloxane bond derived from said silanol group.

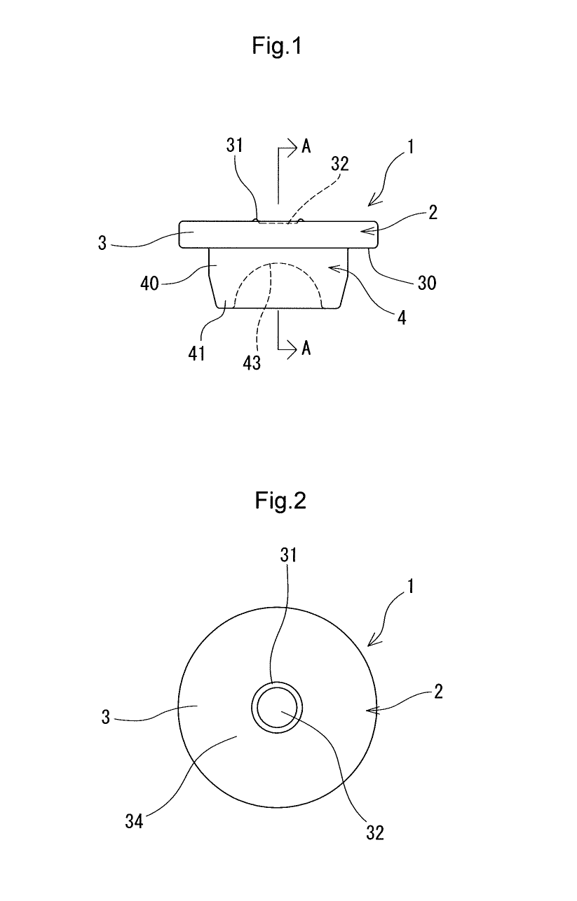

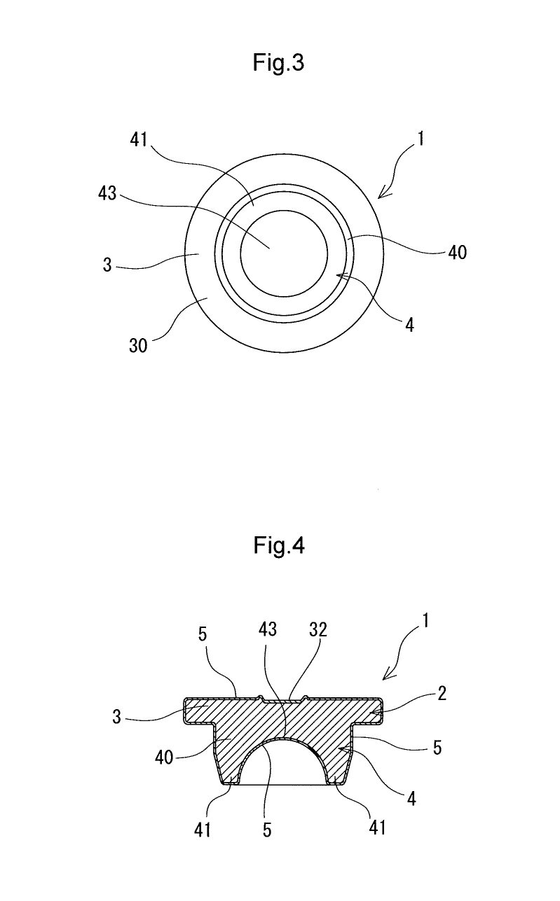

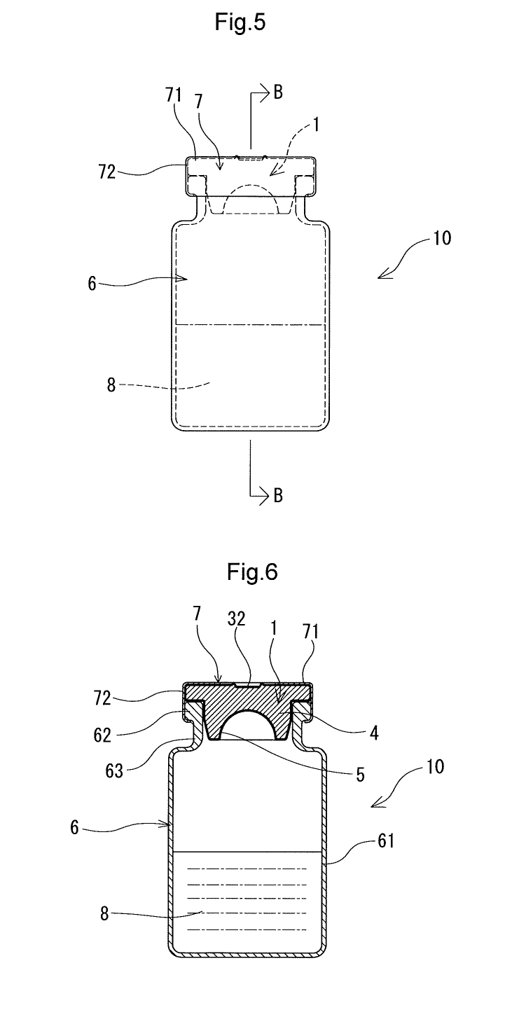

As shown in FIGS. 1 through 4, a rubber stopper 1 of the present invention for a medicine container has a rubber stopper body 2 and a coating layer 5 directly applied to an exposed surface, of the rubber stopper body 2, which is disposed inside the medicine container. The coating layer 5 is more flexible than a material to be used to form the rubber stopper body 2 and is formed of a composition containing silicone-based resin which consists of a condensate of reactive silicone having an end silanol group and which has a siloxane bond derived from a silanol group.

The rubber stopper 1 for the medicine container has the rubber stopper body 2 and the coating layer 5 directly applied to the exposed surface, of the rubber stopper body 2, which is disposed inside the medicine container. As shown in FIGS. 1 through 4, the rubber stopper body 2 has a disk-shaped body part 3 and an entry part 4 which is extended downward into the container from the center of a lower surface of the body part 3 and has an outer diameter smaller than that of the body part. A peripheral portion 30 of the lower surface of the body part 3 constitutes an annular contact portion which contacts an upper surface of an open part 62 of a container body 6 described later.

The entry part 4 disposed inside the container has a cylindrical portion 40 extended in almost the same diameter and a tapered portion 41, provided at a lower end of the cylindrical portion 40, the diameter of which gradually decreases. The entry part 4 disposed inside the container has a concave portion 43 extended upward from a lower-end surface thereof. An upper end of the concave portion 43 is hemispherical. An outer peripheral surface of the entry part 4 disposed inside the container contacts an inner peripheral surface of the medicine container body described later and forms a liquid-tight state. The cylindrical portion 40 is strongly compressed by the inner peripheral surface of the open part of the medicine container body.

An annular rib 31 and a concave portion 32 disposed inside the annular rib 31 are formed on an upper surface 34 of the body part 3. When the rubber stopper 1 of this embodiment is mounted on the medicine container body described later, the lower-end surface of the entry part 4 disposed inside the container and an inner surface of the concave portion are exposed in an inner accommodation part of the medicine container and thus have a possibility of contacting the medicine. There is a possibility that an outer circumference of a lower portion, of the entry part 4 disposed inside the container, having a gradually decreased diameter contacts the medicine.

Although the drawings show one example of the configuration of the rubber stopper body 2. The rubber stopper body may have any configuration, provided that it liquid-tightly seals the open part of the medicine container. Although the above-described rubber stopper body has the entry part 4 disposed inside the container, the rubber stopper body may be so constructed that it does not have the entry part 4 disposed inside the container, but has a cylindrical part which coats the outer side of the open part 62 of the container body 6.

It is preferable that the material for composing the rubber stopper body 2 is an elastic material. Although the elastic material is not limited to specific ones, various rubber materials (subjected to vulcanization treatment) such as natural rubber, isoprene rubber, butyl rubber, chloroprene rubber, nitrile-butadiene rubber, styrene-butadiene rubber, and silicone rubber are exemplified. Diene rubber is especially preferable because it has an elastic property and can be sterilized by γ rays, electron beams, and high-pressure steam.

It is necessary that the coating layer 5 is formed on at least the exposed surface, of the rubber stopper body, which is disposed inside the medicine container. The coating layer 5 is directly applied to at least an outer surface of the rubber stopper body without the intermediary of a film or the like. More specifically, it is necessary that the coating layer 5 is formed on the inner concave portion-included lower surface of the entry part 4 disposed inside the container.

As in the case of this embodiment, it is also preferable to form the coating layer 5 on an outer side surface of the entry part 4, of the rubber stopper body 2, disposed inside the container. This construction makes it easy to insert the rubber stopper body into the open part of the medicine container.

As in the case of this embodiment, it is also preferable to form the coating layer 5 on the upper surface of the body part of the rubber stopper body. This construction securely prevents the medicine from leaking from needle-inserted portions. As in the case of this embodiment, the coating layer 5 may be formed on the entire surface of the rubber stopper body.

The thickness of the coating layer 5 is set to favorably 1 to 30 μm and more favorably 3 to 10 μm. When the thickness of the coating layer 5 is not less than 1 μm, the coating layer displays necessary sliding contact performance. When the thickness of the coating layer 5 is not more than 30 μm, the coating layer does not adversely affect the elasticity of the entire rubber stopper body.

The coating layer 5 more flexible than the material to be used to form the rubber stopper body 2 is used. As the silicone-based resin to be used for the coating layer, it is possible to use solvent-based silicone-based resin dissolved in an organic solvent and water-based silicone-based resin emulsified and dispersed in water. But from the viewpoint of the influence of the silicone-based resin on the material for the rubber stopper body or the aptitude as the liquid medicine accommodation container, the water-based silicone-based resin is preferable. The coating layer 5 is formed of resin composed of a material having a lower friction coefficient than the elastic material composing the rubber stopper body 2.

The coating layer 5 is formed of a composition containing reactive silicone-based resin having an end silanol group and does not contain solid fine particles.

The coating layer 5 is formed of the composition containing the silicone-based resin which consists of the condensate of the reactive silicone having the end silanol group and which has the siloxane bond derived from the silanol group and does not contain solid fine particles.

It is preferable that the composition containing the reactive silicone-based resin is thermosetting silicone-based resin or normal temperature-curable silicone-based resin. It is especially preferable that the composition containing the reactive silicone-based resin is the thermosetting silicone-based resin from the standpoint of its good workability and the like.

It is preferable that the reactive silicone is polydimethylsiloxane having the end silanol group. It is especially preferable that the reactive silicone has the silanol group at its both ends. In a case where polysiloxane-based silicone having the end silanol group is used as the reactive silicone, the condensate of the reactive silicone has the siloxane bond entirely in its entire main chain.

As the reactive silicone having the end silanol group, the polysiloxane-based silicone having the silanol group at its both ends is preferable. Such polysiloxane-based silicone includes both-end silanol polydimethylsiloxane, both-end silanol polydiphenylsiloxane, and both-end silanol diphenylsiloxane-dimethylsiloxane copolymer. The form of the reactive silicone is not limited to specific one, but it is possible to use a reactive silicone siloxane compound, polysiloxane, consisting of a condensate of the reactive silicone siloxane compound, which is dispersed, emulsified, and dissolved in an aqueous medium, a copolymer emulsion obtained by copolymerizing an alkoxysilyl group-containing vinyl monomer with other vinyl monomers, and an emulsion obtained by compositing the polysiloxane and an organic polymer with each other.

It is preferable that the resin composition forming the coating layer 5 contains a second silicone-based compound different from the reactive silicone-based resin having the silanol group or the siloxane bond. As the second silicone-based compound, alkylalkoxysilane, phenylalkoxysilane, alkylphenoxysilane, aminoalkylalkoxysilane, and glycidoxyalkylalkoxysilane are preferable.

It is also favorable that the composition forming the coating layer 5 contains the alkylalkoxysilane or the phenylalkoxysilane as the second silicone-based compound and contains the aminoalkylalkoxysilane or/and the glycidoxyalkylalkoxysilane as a third silicone-based compound.

It is more favorable that the resin composition forming the coating layer contains the alkylalkoxysilane or the phenylalkoxysilane as the second silicone-based compound, the aminoalkylalkoxysilane as the third silicone-based compound, and the glycidoxyalkylalkoxysilane as a fourth silicone-based compound.

As the second silicone-based compound, the alkylalkoxysilane, the alkylphenoxysilane, the phenylalkoxysilane and the like are preferable. The alkylalkoxysilane has at least one alkyl group having 1 to 20 carbon atoms and at least one alkoxy group having 1 to 4 carbon atoms.

As the alkylalkoxysilane, it is possible to use methyltrimethoxysilane, methyltriethoxysilane, methyltriisobutoxysilane, methyltributoxysilane, methyl-sec-trioctyloxysilane, isobutyltrimethoxysilane, cyclohexylmethyldimethoxysilane, diisopropyldimethoxysilane, propyltrimethoxysilane, diisobutyldimethoxysilane, n-octylmethoxysiloxane, ethyltrimethoxysilane, dimethyldimethoxysilane, hexyltrimethoxysilane, hexyltriethoxysilane, octamethylcyclotetrasiloxane, methyltri(acryloyloxyethoxy)silane, octyltriethoxysilane, lauryl triethoxysilane, stearyl trimethoxysilane, sterayl triethoxysilane, ethyltriethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, nonyltrimethoxysilane, nonyltriethoxysilane, decyltrimethoxysilane, decyltriethoxysilane, undecyltrimethoxysilane, undecyltriethoxysilane, dodecyltrimethoxysilane, dodecyltriethoxysilane, tridecyltrimethoxysilane, tridecyltriethoxysilane, tetradecyltrimethoxysilane, tetradecyltriethoxysilane, pentadecyltrimethoxysilane, pentadecyltriethoxysilane, hexadecyltrimethoxysilane, hexa decyltriethoxysilane, heptadecyltrimethoxysilane, heptadecyltriethoxysilane, octadecyltrimethoxysilane, octadecyltriethoxysilane, nonadecyltrimethoxysilane, nonadecyltriethoxysilane, eykosiltrimethoxysilane, eykosiltriethoxysilane and the like.

As the alkylphenoxysilane, methyltriphenoxysilane is preferable. As phenylalkoxysilane, phenyltrimethoxysilane, phenyltriethoxysilane, diphenyldimethoxysilane, diphenyldiethoxysilane and the like are preferable.

As the second silicone-based compound, it is also possible to use methyltri(glycidyloxy)silane, trimethylchlorosilane, dimethylchlorosilane, methyltrichlorosilane, tetraethoxysilane, heptadecafluorodecyltrimethoxysilane, tridecafluorooctyltrimethoxysilane, tetrapropoxysilane and the like.

As the second silicone-based compound, the aminoalkylalkoxysilane may be used. As the aminoalkylalkoxysilane, 3-aminopropyltriethoxysilane, 3-(2-aminoethyl)aminopropyltrimethoxysilane, 3-(2-aminoethyl)aminopropylmethyldimethoxysilane, 3-aminopropyltrimethoxysilane, 3-phenylaminopropyltrimethoxysilane and the like are preferable.

As the second silicone-based compound, the glycidoxyalkylalkoxysilane may be used. As the glycidoxyalkylalkoxysilane, 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohexyl)ethyltrimethoxysilane and the like are preferable.

As the second silicone-based compound, it is possible to use silane-based compounds such as 3-ureidopropyltriethoxysilane, diaryldimethylsilane, n-octyldimethylchlorosilane, tetraethoxysilane, trifluoropropyltrimethoxysilane and the like.

The composition forming the coating layer 5 may contain the second and third silicone-based compounds. It is preferable to select the second silicone-based compound from among the alkylalkoxysilane, the alkylphenoxysilane, and the phenylalkoxysilane. As the third silicone-based compound, it is preferable to use the aminoalkylalkoxysilane or the glycidoxyalkylalkoxysilane.

The composition forming the coating layer may contain the second, third, and fourth silicone-based compounds. It is preferable to select the second silicone-based compound from among the alkylalkoxysilane, the alkylphenoxysilane, and the phenylalkoxysilane. As the third silicone-based compound, the aminoalkylalkoxysilane is preferable. As the fourth silicone-based compound, it is preferable to use the glycidoxyalkylalkoxysilane.

As aqueous silicone-based resin, it is possible to preferably use a polysiloxane composite aqueous emulsion having a core part which is a crosslinked polymer, a shell part which is an uncrosslinked polymer and coats the core part, and polysiloxane in the vicinity of the shell.

The method of forming the coating layer 5 is described below. In the method of forming the coating layer, a coating solution is prepared by dispersing and suspending a composition containing necessary amounts of necessary components of the silicone-based resin in purified water. The coating layer is obtained by applying the coating solution to the clean surface of the rubber stopper body and thereafter hardening the coating solution. At this time, the coating solution can be applied to the surface of the rubber stopper body by carrying out a known method such as a dip coating method, a spraying method, and the like. It is preferable to apply the coating solution to the surface of the object to be coated by spray coating with the object being rotated (specifically, at 100 to 600 rpm). In applying the coating solution to the surface of the object to be coated by the spray coating, it is preferable to do so after heating portions of the rubber stopper body to be coated to 60 to 120 degrees C. Thereby the coating solution can be quickly fixed to the surface of the portions of the rubber stopper body to be coated without water repellency.

As the method of hardening the coating solution, it may be left at a normal temperature, but it is preferable to thermally harden the coating solution. Although the method of thermally hardening the coating solution is not limited to a specific method, a hot-air drying method and a drying oven using infrared rays can be used so long as the base material of the rubber stopper body is not modified or deformed. It is possible to use a conventional method such as a method of using a drier to be operated under a reduced pressure. The thickness of the coating layer to be formed is 1 to 30 μm and preferably 3 to 10 μm. Such a coating layer can be easily formed by appropriately controlling the concentration of a mixed solution, an immersing method, and a spraying method.

In preparing the coating solution containing the silicone-based resin, a catalyst for accelerating thermosetting may be used as an additive. As the catalyst, although acid, alkali, amine, organic salts of metals, titanate, and borate are used. Zinc octylate, iron octylate or organic acid salts of cobalt, tin, and lead are preferable.

As the organic acid salts of tin, it is possible to use bis(2-ethylhexanoate)tin, bis(neodecanoate)tin, di-n-butylbis(2-ethylhexylmaleate)tin, di-n-butylbis(2,4-pentanedionate)tin, di-n-(butylbutoxychloro)tin, di-n-butyl diacetoxy tin, di-n-butyltin dilaurate, dimethyltin neodecanoate, dimethyl hydroxy(oleate)tin, and dioctytin dilaurate.

In preparing the coating solution containing the silicone-based resin, additives such as a surface-active agent, alcohol, and the like may be used to uniformly emulsify, suspend, and disperse the coating solution.

As the surface-active agent, anion surface active agents are preferable. Although any anion surface active agent can be used, it is possible to use aliphatic monocarboxylate, polyoxyethylene alkyl ether carboxylate, N-acyl sarcosinate, N-acyl glutamate, dialkyl sulfosuccinate, alkanesulfonate, alpha olefin sulfonate, straight chain alkylbenzene sulfonate, molecular chain alkylbenzene sulfonate, naphthalene sulfonate-formaldehyde condensate, alkyl naphthalene sulfonate, N-methyl-N-acyl taurine, alkyl sulfate, polyoxyethylene alkyl ether sulfate, fats and oils sulfuric acid ester salt, alkyl phosphate, polyoxyethylene alkyl ether sulfate, polyoxyethylene alkyl phenyl ether sulfate and the like.

Nonionic (nonion) surface active agents may be used. Although any nonionic surface-active agent may be used, it is possible to use polyoxyethylene alkyl ether, polyoxyalkylene derivatives, polyoxyethylene alkyl phenyl ether, polyoxyethylene sorbitan fatty acid ester, fatty acid alkanolamide, glycerin fatty acid ester, sorbitan fatty acid ester, polyoxyethylene alkylamine, alkyl alkanolamide and the like.

The medicine-accommodated medicine container 10 of the present invention has the medicine container body 6 having the open part, the rubber stopper 1, for the medicine container, which is mounted on the open part of the medicine container body 6 and seals the open part, and the medicine 8 accommodated inside the medicine container body 6.

Any type of the medicine container body 6 can be used, provided that it has the open part and is capable of accommodating the medicine 8 inside it. For example, it is possible to use a container made of hard or semi-hard synthetic resin or glass. The medicine container body 6 has a cylindrical body part 61 whose lower end is closed, an open part 62 having a thick flange, and a neck part 63 which is formed between the open part 62 and the body part 61 and has a smaller diameter than the other parts. A part ranging from the open part 62 of the medicine container body 6 to the neck part 63 thereof constitutes the accommodation part for accommodating the entry part 4, of the rubber stopper 1, which is extended in the same inner diameter inside the container.

As the hard or semi-hard synthetic resin to be used to form the medicine container body 6, the following synthetic resins are preferable: various general purpose hard plastic materials such as polyolefin including polypropylene, polyethylene, poly(4-methylpentene-1), and cyclic polyolefin; polyesters such as polyethylene terephthalate, polyethylene naphthalate, and non-crystalline polyarylate; polystyrene, polyamide, polycarbonate, polyvinyl chloride, acrylic resin, acrylonitrile-butadiene-styrene copolymer, non-crystalline polyetherimide and the like. The polypropylene, the poly (4-methylpentene-1), the cyclic polyolefin, the polyethylene naphthalate, and the non-crystalline polyetherimide are especially preferable because these synthetic resins are preferable in the transparency thereof and the resistance thereof to heat sterilization.

The kinds of the medicine 8 to be accommodated inside the medicine container body are not limited to specific ones, but the following medicines can be accommodated inside the medicine container body: platinum-based anti-cancer agents, protein preparations such as insulin, nitroglycerin, isosorbide dinitrate, nicardipine hydrochloride, monoammonium glycyrrhizinate, antitumor agents, vitamin pills (multivitamin preparations), various amino acids, anti-thrombotic agents such as heparin, antibiotics, analgesic preparations, cardiotonic agents, intravenous anesthetic agents, antiparkinson agents, tumor therapeutic agents, adrenocortical hormone agents, antiarrhythmic agents are exemplified. The dosage form of the medicine is not limited to a specific one, but it is possible to use any of a liquid medicine, a powdery medicine, a freeze-dried medicine, and a solid medicine.

The medicine-accommodated medicine container 10 of this embodiment has a covering member 7 which coats a peripheral portion of the open part 62 of the medicine container body 6 on which the rubber stopper 1 is mounted and a peripheral portion of the rubber stopper 1. It is preferable that the covering member 7 is formed of an aluminum film or a heat-shrinkable film and in close contact with the rubber stopper and the medicine container body. The covering member 7 may be so formed as to entirely cover the upper surface of the rubber stopper 1, provided that the covering member allows a piercing needle such as an injection needle to be pierced therethrough. In this embodiment, the covering member 7 has an annular part 72 and a thin disk-shaped upper surface part 71. The lower-end of the annular part 72 coats an annular lower surface of a flange of the open part 62 of the body part 61 of the container.

The pressure of the inside of the medicine container 10 may be decreased.

### EXAMPLES

Concrete examples of the present invention are described below.

### Example 1

### 1) Preparation of Rubber Stopper Body

By using butyl rubber, a rubber stopper body, having a configuration shown in FIGS. 1 through 4, for a vial container was prepared. The rubber stopper body was prepared by press molding and vulcanizing a vulcanizable rubber composition consisting of the butyl rubber to which an additive was added. Regarding the configuration of the obtained rubber stopper body, its entire length was 7 mm, the outer diameter of the body part was 13 mm. The length of the entry part disposed inside the medicine container was 4 mm, a outer diameter of the entry part was 8 mm, an inner diameter of the concave portion of the entry part was 4 mm, a maximum depth of the concave portion of the entry part was 3 mm.

### 2) Preparation of Coating Solution

### (Component 1a)

43 g of 1,5-diethenyl-3,3-bis[(ethenyldimethyl cyryl)oxy]-1,1,5,5-tetramethylpentanetrisiloxane, 445 g of octamethylcyclotetrasiloxane, 1.5 g of trifluoromethanesulfonic acid were weighed and put in a 1-liter eggplant flask. These reactants were reacted with one another at 80 degrees C. for six hours under stirring. The temperature of the reactants was returned to room temperature. After 1.2 g of calcium carbonate was added to the reactants, the mixture was stirred for three hours. After the calcium carbonate was removed from the mixture by performing a filtration operation, polymerization was completed. The reactants were subjected to stripping treatment at 150 degrees C. for two hours under a decreased pressure (3 kPa). Polysiloxane having a branch structure was obtained by performing polymerization. The viscosity of the obtained polysiloxane was 53 mPa·s. The content of a vinyl group was 2.2 wt %. The obtained preparation was used as a component 1a.

### (Component 1b)

Polymethyl hydrogen siloxane (the content of a hydrogen group bonded to silicon atom was 100 mol %, viscosity: 30 mPa·s, molecular weight: 2,100) having a trimethylsilyl group at both ends thereof was used as a component 1b.

### (Component 2)

Polydimethylsiloxane (viscosity: 50 mPa·s, the content of platinum: 3 wt %) in which both ends of a platinum-divinyltetramethyldisiloxane complex consist of a vinyl group and 10 wt % of ethynyl cyclohexanol were mixed with each other to use the mixture as a component 2.

### (Component 3)

Methyltriethoxysilane, γ-ureidopropyltriethoxysilane, and γ-glycidoxypropyltrimethoxysilane were used as a component 3.

### (Coating Solution)

100 g of the component 1a, 7.4 g of the component 1b, 0.33 g of the component 2, 1 g of the methyltriethoxysilane which was one of the component 3, 1 g of the γ-ureidopropyltriethoxysilane which was also one of the component 3, and 5 g of the γ-glycidoxypropyltrimethoxysilane which was also one of the component 3 were mixed with one another to prepare a coating solution. The viscosity (25 degrees C.) of the coating solution was 46 mPa·s.

### 3) Coating Work

After the rubber stopper body for the vial container produced in the above-described way at a room temperature and a normal pressure was heat-treated at 90 degrees C. for 30 minutes. While rotating the rubber stopper body about its central axis, the coating solution was applied to the rubber stopper for 0.3 seconds by spray coating from the height of 55 mm. Thereafter the rubber stopper body applied the coating solution was dried at 150 degrees C. for 30 minutes. In this way, the rubber stopper of the present invention was produced. Thereafter to wash an extra coating solution present on the surface of the rubber stopper, the surface of the rubber stopper was cleaned with purified water. The average thickness of the coating layer formed on the surface of the rubber stopper was 10 μm.

### Comparison Example 1

Except that the coating solution application height and period of time were altered, a rubber stopper (comparison example 1) was produced in a manner similar to that of the example 1. In performing a coating work, after the coating solution was sprayed to the rubber stopper for 0.1 seconds from the height of 115 mm, the coating solution was dried at 150 degrees C. for 30 minutes. The average thickness of the coating layer formed on the surface of the rubber stopper of the comparison example 1 was 0.5-μm.

### Comparison Example 2

Except that a silicone polymerized film was formed by polymerizing (including crosslinking) reactive silicone oil contained in a liquid coating agent (trade name: Dow Corning Toray Co., Ltd./MDX4-4159) as the main component thereof at a normal temperature or by heating it, a rubber stopper (comparison example 2) was produced in a manner similar to that of the example 1. The average thickness of the coating layer formed on the surface of the rubber stopper of the comparison example 2 was 0.5 μm.

### Comparison Example 3

A rubber stopper (comparison example 3) was produced by forming a coating layer consisting of poly(chloro-para-xylylene) on the surface of the rubber stopper body for the vial container prepared in the example 1.

As the material for the chloro-para-xylylene, a monochloro paraxylene dimer [dichloro-(2,2)-paracyclophane] (trade name: dix-c produced by Daisan Kasei Co., Ltd.) was used. In performing a coating operation, the above-described rubber stopper body was supplied to a chemical vapor deposition apparatus (model: S, capacity of tumbler: 25 L, produced by Daisan Kasei Co., Ltd.) constructed of a vaporizing chamber, a pyrolysis chamber, and a vapor deposition chamber to form the coating layer consisting of the poly(chloro-para-xylylene) on the surface of the rubber stopper body by vapor deposition.

More specifically, after the dichloro-(2,2)-paracyclophane which is the dimer was supplied to the vaporizing chamber, the pressure inside the apparatus was adjusted to a vacuum degree of 30 mTorr. After the vaporizing chamber was heated to 150 to 170 degrees C. to sublimate the dichloro-(2,2)-paracyclophane which is the dimer disposed inside the vaporing chamber, the dimer was passed through the pyrolysis chamber having a temperature of 650 to 690 degrees C. to thermally decompose the dimer to monomers. Finally, the monomers were guided to the vapor deposition chamber (room temperature), having a tumbler, which accommodates 100 rubber stoppers to treat the rubber stoppers for 100 minutes to form a coating layer on the surface of each rubber stopper. The tumbler was rotated at 2 rpm to form the coating layer on each rubber stopper while the rubber stopper was being stirred. After the coating layer was formed on the surface of each rubber stopper, 30 rubber stoppers of the comparison example 3 were arbitrarily selected. The average thickness of the coating layers was 1 μm.

The following tests were conducted on the rubber stoppers, for the vial container, of the example and the comparison examples.

### Experiment 1: Elution Test

Based on “7.03 test for rubber stopper for transfusion” described in Japanese Pharmacopeia, the test was conducted. The test results were as shown in table 1. It could be confirmed that the rubber stopper of the example 1 had the effect of restraining the components of its material from eluting.

The mark “o” in table 1 indicates “satisfactory” (the elution of the components of the material used to form the rubber stopper was restrained). The mark “x” indicates “unsatisfactory” (the elution of the components of the material used to form the rubber stopper was recognized).

### Experiment 2: Resealability Test

A plurality of rubber stoppers of each of the example 1 and the comparison examples 1 through 3 was prepared and mounted on vial containers containing 5 ml of water. After an aluminum cap was wound around each vial, a 18G metal needle was inserted into the rubber stopper with the rubber stopper facing downward. The amount of liquid which leaked from the rubber stopper was measured when the needle was removed therefrom. The test results were as shown in table 1. It could be confirmed that the rubber stopper of the example 1 had a resealability.

### Experiment 3: Airtightness Test

0.62 g of tablet-type silica gel desiccant (Yamani Chem. Co., Ltd.) was accurately measured per piece and put in 10 ml vial containers (10 pieces for each of the example 1 and the comparison examples 1 through 3). Thereafter each vial container was capped at a normal pressure with the rubber stopper of each of the example 1 and the comparison examples 1 through 3.

After each of the sealed vial containers was preserved inside a constant temperature bath at 40 degrees C. and humidity of 75% for one month, the silica gel desiccant was taken out from the vial containers. Thereafter the weight of each silica gel desiccant was accurately measured to calculate an increase (change in the weight of the silica gel desiccant owing to moisture absorption) of the weight thereof. The test results were as shown in table 1. The fractions shown in table 1 indicate “the number of leakages (the difference in the weight of the desiccant between before the desiccant was put in the vial container and when the desiccant was taken out therefrom was not less than 10 mg)/the total number (10 pieces) of the vial containers”. It could be confirmed that the rubber stopper of the example 1 was broken to a low extent when the vial container was capped with the rubber stopper and thus had a high degree of air tightness.

TABLE 1

| | Elution test | Resealability test | Airtightness test |
|---|---|---|---|
| Example 1 | ∘ | 40 mg | 0/10 |
| Comparison | x | 230 mg | 0/10 |
| example 1 | | | |
| Comparison | x | 280 mg | 0/10 |
| example 2 | | | |
| Comparison | ∘ | 40 mg | 3/10 |
| example 3 | | | |

### INDUSTRIAL APPLICABILITY

The rubber stopper of the present invention for the medicine container is as described below.

(1) A rubber stopper for a medicine container comprising

a rubber stopper body and a coating layer directly applied to a surface of said rubber stopper body exposed in said medicine container,

wherein said coating layer is more flexible than a forming material of said rubber stopper body and

said coating layer comprises a composition containing a silicone-based resin which comprises a condensate of a reactive silicone having a terminal silanol group, and wherein said condensate contains a siloxane bond derived from said silanol group.

The rubber stopper of the present invention for the medicine container maintains a high degree of flexibility, does not adsorb a medicine, prevents the components forming the rubber stopper from eluting from the material used to form the rubber stopper, and prevents the medicine from flowing out from pierced portions of the rubber stopper even though the rubber stopper is subjected to the piercing of an injection needle at a plurality of times because the rubber stopper has a satisfactory resealability.

The above-described embodiment of the present invention may be as described below.

(2) A rubber stopper for a medicine container according to the above (1), wherein said reactive silicone is polydimethylsiloxane having said end silanol group.
(3) A rubber stopper for a medicine container according to the above (1) or (2), wherein said reactive silicone has said silanol group at both ends thereof.
(4) A rubber stopper for a medicine container according to any one of the above (1) through (3), wherein said composition contains a second silicone compound different from said silicone-based resin having said siloxane bond.
(5) A rubber stopper for a medicine container according to any one of the above (1) through (3), wherein said composition contains alkylalkoxysilane, phenylalkoxysilane, aminoalkylalkoxysilane or glycidoxyalkylalkoxysilane as a second silicone compound different from said silicone-based resin having said siloxane bond.
(6) A rubber stopper for a medicine container according to any one of the above (1) through (3), wherein said composition contains alkylalkoxysilane or phenylalkoxysilane as a second silicone compound different from said silicone-based resin having said siloxane bond; and further contains aminoalkylalkoxysilane or/and glycidoxyalkylalkoxysilane as a third silicone-based compound.
(7) A rubber stopper for a medicine container according to any one of the above (1) through (3), wherein said composition contains alkylalkoxysilane or phenylalkoxysilane as said second silicone compound different from said silicone-based resin having said siloxane bond; further contains aminoalkylalkoxysilane as a third silicone compound; and glycidoxyalkylalkoxysilane as a fourth silicone compound.
(8) A rubber stopper for a medicine container according to any one of the above (1) through (3), wherein said reactive silicone has said terminal silanol group at both ends thereof, and said composition contains an alkylalkoxysilane or a phenylalkoxysilane as a second silicone compound different from said silicone-based resin having said siloxane bond, an aminoalkylalkoxysilane or a glycidoxyalkylalkoxysilane as a third silicone compound.
(9) A rubber stopper for a medicine container according to any one of the above (1) through (8), wherein said silicone-based resin is thermosetting silicone-based resin.
(10) A rubber stopper for a medicine container according to any one of the above (1) through (9), wherein said coating layer has a thickness of 1 to 30 μm.

The medicine-accommodated medicine container of the present invention is as described below.

(11) A medicine-accommodated medicine container comprising a medicine container body having an open part; a rubber stopper for a medicine container, according to the above (1) through (10), which is mounted on an open part of said medicine container body and seals said open part; and a medicine accommodated inside said medicine container body.

The medicine-accommodated medicine container of the present invention prevents the rubber stopper from adsorbing a medicine, components forming the rubber stopper from eluting from the material used to form the rubber stopper, and prevents the medicine from flowing out from pierced portions of the rubber stopper even though the rubber stopper is subjected to the piercing of an injection needle at a plurality of times.

The embodiment of the present invention may be as described below.

(12) A medicine-accommodated medicine container according to the above (11), wherein said medicine-accommodated medicine container has a covering member which covers a peripheral portion of said open part of said medicine container on which said rubber stopper is mounted and a peripheral portion of said rubber stopper.

1. A rubber stopper for a medicine container comprising
a rubber stopper body and a coating layer directly applied to a surface of said rubber stopper body exposed in said medicine container,
wherein said coating layer is more flexible than a forming material of said rubber stopper body and
said coating layer comprises a composition containing a silicone-based resin which comprises a condensate of a reactive silicone having a terminal silanol group, and wherein said condensate contains a siloxane bond derived from said silanol group.

2. A rubber stopper for a medicine container according to claim 1, wherein said reactive silicone is polydimethylsiloxane having said end silanol group.

3. A rubber stopper for a medicine container according to claim 1, wherein said reactive silicone has said silanol group at both ends thereof.

4. A rubber stopper for a medicine container according to claim 1, wherein said composition contains a second silicone compound different from said silicone-based resin having said siloxane bond.

5. A rubber stopper for a medicine container according to claim 1, wherein said composition contains alkylalkoxysilane, phenylalkoxysilane, aminoalkylalkoxysilane or glycidoxyalkylalkoxysilane as a second silicone compound different from said silicone-based resin having said siloxane bond.

6. A rubber stopper for a medicine container according to claim 1, wherein said composition contains alkylalkoxysilane or phenylalkoxysilane as a second silicone compound different from said silicone-based resin having said siloxane bond; and further contains aminoalkylalkoxysilane or/and glycidoxyalkylalkoxysilane as a third silicone-based compound.

7. A rubber stopper for a medicine container according to claim 1, wherein said composition contains alkylalkoxysilane or phenylalkoxysilane as said second silicone compound different from said silicone-based resin having said siloxane bond; further contains aminoalkylalkoxysilane as a third silicone compound; and glycidoxyalkylalkoxysilane as a fourth silicone compound.

8. A rubber stopper for a medicine container according to claim 1, wherein said reactive silicone has said terminal silanol group at both ends thereof, and said composition contains an alkylalkoxysilane or a phenylalkoxysilane as a second silicone compound different from said silicone-based resin having said siloxane bond, an aminoalkylalkoxysilane or a glycidoxyalkylalkoxysilane as a third silicone compound.

9. A rubber stopper for a medicine container according to claim 1, wherein said silicone-based resin is thermosetting silicone-based resin.

10. A rubber stopper for a medicine container according to claim 1, wherein said coating layer has a thickness of 1 to 30 μm.

11. A medicine-accommodated medicine container comprising a medicine container body having an open part; a rubber stopper for a medicine container, according to claim 1, which is mounted on an open part of said medicine container body and seals said open part; and a medicine accommodated inside said medicine container body.

12. A medicine-accommodated medicine container according to claim 11, wherein said medicine-accommodated medicine container has a covering member which covers a peripheral portion of said open part of said medicine container on which said rubber stopper is mounted and a peripheral portion of said rubber stopper.
